(19) United States
(12) Patent Application Publication
(10) Pub. No.: US 2020/0366947 A1
(43) Pub. Date: Nov. 19, 2020

(54) ATSC 3.0 STANDARD CONFORMITY ASSESSMENT TEST SYSTEM

(71) Applicant: LOWASIS Inc., Daegu (KR)

(72) Inventors: Young Hun LEE, Seoul (KR); Yong Suk KIM, Seoul (KR)

(21) Appl. No.: 16/829,292

(22) Filed: Mar. 25, 2020

(30) Foreign Application Priority Data
May 17, 2019 (KR) 10-2019-0058407

(51) Int. Cl. H04N 21/24; H04N 21/858; H04N 21/643; H04N 21/64; H04N 21/266; H04L 12/26

(52) U.S. Cl. CPC H04N 21/24; H04N 21/8586; H04L 43/50; H04N 21/64; H04N 21/266; H04N 21/64322

(57) ABSTRACT

An ATSC 3.0 standard conformity assessment test system is configured to automatically perform an ATSC 3.0 standard conformity assessment test. The system includes: a broadcast network transmitter for modulating inputted transmission data according to a number of modulation combinations defined by the ATSC 3.0 standard to generate a broadcast network assessment stream, and transmitting the generated broadcast network assessment stream through a broadcast network (RF) in response to a control signal applied thereto; an IP test server for transmitting a communication network test stream for an Internet-based ATSC 3.0 service test using an IP communication network in response to a control signal applied thereto; and a device under test (DUT) for transmitting reception information with respect to the broadcast network assessment stream transmitted from the broadcast network transmitter and the communication network test stream transmitted from the IP test server to the IP test server through a feedback channel.

### CROSS-REFERENCE TO RELATED APPLICATIONS

This application claims the benefit of Korean Patent Application No. 10-2019-0058407, filed on May 17, 2019 in the Korean Intellectual Property Office, which is incorporated herein by reference in its entirety.

### BACKGROUND OF THE INVENTION

### 1. Field of the Invention

The present invention relates to an ATSC 3.0 standard conformity assessment test system, and more particularly, to an ATSC 3.0 standard conformity assessment test system that is configured to perform an ATSC 3.0 standard conformity assessment test in an automatic and efficient manner.

### 2. Description of Related Art

In general, the Advanced Television Systems Committee (ATSC) refers to a private organization that developed standards for digital television broadcasting in the United States or its standard. The ATSC standard has been adopted as a state standard of the US, Canada, Mexico and Korea.

The ATSC 3.0 technology updated to various functions and technologies is a technology that enables bidirectional hybrid services because a broadcast network and a communication network are simultaneously utilized by using IP for unidirectional broadcast based on a conventional radio frequency (RF) broadcast network. Examples of the bidirectional hybrid services include a personalized broadcasting service employing a dynamic linkage and a companion device, a service accessibility improvement employing an advanced electronic program guide (EPG), and the like.

However, the unidirectional broadcast system based on the existing ATSC standard entails a problem in that it cannot provide all the bidirectional hybrid services according to the above-mentioned ATSC 3.0.

Therefore, the development of an ATSC 3.0 standard-based broadcast system is required, and to implement this, there is a need for an apparatus for testing and verifying whether or not a broadcast system developed based on the ATSC 3.0 conforms to the ATSC 3.0 standard.

However, unlike an IP test environment based on an IP network enabling bidirectional transmission in performing an IP test and a broadcast network reception test using the ATSC 3.0 standard conformity assessment test system, a broadcast network is basically a unidirectional network. Thus, there occurs a problem in that since a result of each test suite related to the broadcast network cannot be acquired automatically in the test system, it is required that the result (pass/fail) of each test suite should be conventionally identified by a manual work through an operator's intervention and then a test should be conducted.

### PRIOR ART LITERATURE

[Patent Document]

Patent Document: Korean Patent Laid-Open Publication No. 10-2018-0070462

### SUMMARY OF THE INVENTION

Accordingly, the present invention has been made to solve the aforementioned problems occurring in the prior art, and it is an object of the present invention to provide an ATSC 3.0 standard conformity assessment test system that can perform an ATSC 3.0 standard conformity assessment test in an automatic and efficient manner without any human interventions.

To achieve the above object, in one aspect, the present invention provides a ATSC 3.0 standard conformity assessment test system configured to automatically perform an ATSC 3.0 standard conformity assessment test, the system including: a broadcast network transmitter for modulating inputted transmission data according to a number of modulation combinations defined by the ATSC 3.0 standard to generate a broadcast network assessment stream, and transmitting the generated broadcast network assessment stream through a broadcast network (RF) in response to a control signal applied thereto; an IP test server for transmitting a communication network test stream for an Internet-based ATSC 3.0 service test using an IP communication network in response to a control signal applied thereto; a device under test (DUT) for transmitting reception information with respect to the broadcast network assessment stream transmitted from the broadcast network transmitter and the communication network test stream transmitted from the IP test server to the IP test server through a feedback channel; and a test tool controller for fetching a test suite including a test item, a procedure, assessment automation, and a test stream, which have been stored in a memory and outputting control signals for transmission of the communication network test stream and the broadcast network assessment stream, respectively, to the IP test server and the broadcast network transmitter, and determining success and failure (pass/fail) of reception based on the reception information inputted thereto from the device under test (DUT) through the IP test server.

### Effects of the Invention

As described above, the present invention has advantageous effects in that it can be utilized for the ATSC 3.0 standard conformity self-assessment of a reception equipment manufacturer so that the development of a reception equipment can be executed effectively, leading to the growth of a ATSC 3.0 standard conformity assessment equipment industry to enable creation of both new production manpower and employment opportunities for the unemployed. In addition, the present invention has another effect in that it can be reflected to the development of an ATSC 3.0 standard conformity assessment program and can be utilized for standardization and designation of a standard test tool.

### BRIEF DESCRIPTION OF THE DRAWINGS

The above and other objects, features and advantages of the present invention will be apparent from the following detailed description of the preferred embodiments of the invention when taken in conjunction with the accompanying drawings, in which:

FIG. 1 is a block diagram illustrating a ATSC 3.0 standard conformity assessment test system according to the present invention;

FIG. 2 is a view illustrating an example of a CDM message transmitted to a DUT according to the present invention; and

FIG. 3 is a diagram illustrating a GUI of a broadcast network transmitter according to the present invention.

### DETAILED DESCRIPTION OF THE PREFERRED EMBODIMENTS

Hereinafter the detailed configuration of an ATSC 3.0 standard conformity test system according to an embodiment of the present invention will be described in detail with reference to the accompanying drawings.

First, a test specification applied to the ATSC 3.0 standard conformity assessment test system of the present invention is schematically shown in Table 1 below.

TABLE 1

| Test Specification | |
|---|---|
| Classification | Contents |
| RF | Confirmation of implementation of various |
| | modulation combinations (Mod-Cod) |
| Component | Conformity assessment of components (video, |
| | audio, etc.) as contents of broadcast service |
| System | Confirmation of implementation of signaling and |
| | multiplexing standard |
| Broadband | Confirmation of compatibility of IP-based |
| | broadcast service |
| Bidirectional | Confirmation of compatibility of App, |
| hybrid service | Push service, etc. |

Among them, the specific assessment items for the RF test specification are shown in Table 2 below.

TABLE 2

| No. | Test Items | Contents |
|---|---|---|
| 1 | Frequency | Confirmation of support of relevant |
| | domain | frequency in DUT through setting at set |
| | | frequency and bandwidth |
| 2 | Frequency error | Confirmation of maximum reception- |
| | resistance | enabling frequency error by Mod-cod |
| | performance | set |
| 3 | Mod-cod set | Confirmation of relevant Mod-cod set |
| | reception | reception function in DUT through setting |
| | function | of transmission parameters by Mod-cod set |
| 4 | SFN operation | Confirmation of SFN-2 path reception |
| | confirmation | function of DUT through two associated |
| | | transmission functions |
| 5 | Maximum | Confirmation of maximum reception-enabling |
| | reception | input signal level of DUT through output |
| | level | signal adjustment function |
| | confirmation | |

The test items according to the RF test specification are defined to perform the following functions. In other words, the test items allow for confirmation of the operation of a device under test (DUT) at the entire frequency for the north-American service, including the entire frequency range for the ATSC 3.0 service in the north America, and allows for confirmation of frequency error resistance performance of a multicarrier transmission scheme susceptible to frequency errors so that whether or not reception is possible can be assessed despite the occurrence of the frequency error in a local oscillator (LO) of a transmitter. In addition, the test items allow for confirmation of a reception function according to Mod-cod set of the ATSC 3.0 standard so that the operation of a receiver can be checked previously at the time of setting various transmission parameters according to broadcasting stations. Further, the test items allow for confirmation of an SFN-2 path reception function so that frequencies of broadcasting stations can be assigned which have constructed a plurality of transmission facilities since the ATSC 3.0 standard supports a single frequency network (SFN), and also allow for confirmation of a maximum reception level to check an erroneous operation due to AGC and RF saturation of the receiver.

In this case, the number of cases where various modulation combinations are possible which are permitted in the ATSC 3.0 physical layer specification for the Mod-cod set test of the ATSC 3.0 standard is considerably large as shown in Tables 3 and 4 below. Thus, when a method is used which allows a test engineer to set the test items, i.e., the number of cases where the modulation combinations are possible and to confirm a result of the setting personally, and then to re-assess the result, it is difficult to test the number of all the cases possible.

Accordingly, the present invention enables to automatically set the number of cases where various modulation combinations are possible and automatically confirm a result of the setting, and then assess the result.

TABLE 3

| | Code Rate | | | | | | | | | | | |
|---|---|---|---|---|---|---|---|---|---|---|---|---|
| Constellation | 2/15 | 3/15 | 4/15 | 5/15 | 6/15 | 7/15 | 8/15 | 9/15 | 10/15 | 11/15 | 12/15 | 13/15 |
| QPSK | ✓ | ✓ | ✓ | ✓ | ✓ | ✓ | ✓ | ✓ | | ✓ | | |
| 16QAM | | | ✓ | ✓ | | ✓ | ✓ | ✓ | | ✓ | | |
| 64QAM | | ✓ | ✓ | ✓ | ✓ | ✓ | ✓ | ✓ | ✓ | ✓ | | |
| 256QAM | | | ✓ | ✓ | | ✓ | ✓ | ✓ | ✓ | ✓ | ✓ | ✓ |
| 1024QAM | | | | ✓ | | ✓ | ✓ | ✓ | ✓ | ✓ | ✓ | ✓ |
| 4096QAM | | | | | | ✓ | | ✓ | | ✓ | ✓ | ✓ |

TABLE 4

| | Code Rate | | | | | | | | | | | |
|---|---|---|---|---|---|---|---|---|---|---|---|---|
| Constellation | 2/15 | 3/15 | 4/15 | 5/15 | 6/15 | 7/15 | 8/15 | 9/15 | 10/15 | 11/15 | 12/15 | 13/15 |
| QPSK | ✓ | ✓ | ✓ | ✓ | ✓ | ✓ | ✓ | ✓ | | | | |
| 16QAM | | | | ✓ | ✓ | ✓ | ✓ | | | ✓ | | |
| 64QAM | | | | ✓ | ✓ | ✓ | ✓ | ✓ | ✓ | ✓ | | |
| 256QAM | | | | ✓ | | ✓ | ✓ | ✓ | ✓ | ✓ | ✓ | ✓ |

Table 3 above indicates an obligatory implementation matter in which the number of obligatory implementation matters of code rate and constellation is 64,800 bits in an ATSC 3.0 physical layer specification transmission monde, and Table 4 above indicates an obligatory implementation matter in which the number of obligatory implementation matters of code rate and constellation is 16,200 bits. Tables 3 and 4 above cite Table 6.12 and Table 6.12 of Section 6.3.2 of ATSC 3.0: A/322:2017.

In addition, the component test specification is designed to test video and audio, respectively. The test items for assessment of the video function and performance are shown in Table 5 below.

TABLE 5

| No. | Test Items | Contents |
|---|---|---|
| 1 | Video Format | ATSC 3.0 standard video format |
| | | identification |
| 2 | Spatially | Function of decoding a spatially |
| | Scalable | scalable coded video stream consisting |
| | Coded | of a base layer and an enhancement layer |
| | Video | (based on ATSC A/341 standard) |
| 3 | HDR and | Various supports of video transfer |
| | Video | characteristics (SDR, PQ, HLG) and |
| | Transfer | switching confirmation |
| | Characteristics | |
| 4 | Video Codec | Confirmation of video coding |
| | | characteristics of HEVC codec |
| | | (HEVC conformance) |

A service-enabling video format in the north-American ATSC 3.0 standard diversely ranges from legacy SD to UHD resolution, and this service resolution is determined by broadcasting stations. Thus, whether or not to support the resolution, i.e., the entire format is identified in consideration of service scalability later, a scalable video codec technology for simultaneously satisfying the transmission efficiency during the video coding and the diversity of a receiving terminal is defined by the ATSC 3.0 standard, and thus this is confirmed. In addition, it is confirmed whether or not various video transfer technologies defined by the ATSC 3.0 standard can be applied to increase video service satisfaction, and the ATSC 3.0 standard is defined to use HEVC codec for video coding. Thus, the video test items of the component test specification are defined to perform the basic compatibility verification for the HEVC codec.

In addition, the test items for the audio function and performance assessment are shown in Table 6 below.

TABLE 6

| | | |
|---|---|---|
| No. | Test Items | Contents |

| | | | |
|---|---|---|---|
| 1 | AC-4 | Decoder | Confirmation of presentation function |
| | | level | by compatibility level |
| 2 | | Audio | Confirmation of AC-4 native frame rate |
| | | frame | (48,000/2048) and 100, 120/1.001, 120 |
| | | rate | fps support |
| 3 | | Loudness | Support of DRC metadata, Loudness |
| | | and DRC | metadata |
| | | | Confirmation of E-AC-3 DRC |
| | | | profile and parameteric DRC curve |
| | | | support |
| | | | Confirmation of Loudness |
| | | | and DRC function support |
| 4 | | Dialog | Confirmation of processing function |
| | | enhancement | according to dialog enhancement |
| | | | metadata in AC-4 bit stream |
| | | Presentation | Selection of various presentations |
| | | selection | in AC-4 bit stream |
| | | Down-mix | Confirmation of whether two-channel |
| | | mode | output is processed in down-mix mode |
| | | | defined by the ATSC 3.0 standard |
| 5 | MPEG-H | Profile | Confirmation of support of MPEG-HLC |
| | | level | (low complexity) profile levels 1, |
| | | | 2 and 3 |
| 6 | | RAP | Confirmation of audio output within |
| | | performance | 100 msec at RAP (random access point) |
| 7 | | Loudness | Confirmation of control of loudness |
| | | and DRC | and DRC transferred through MPEG-H |
| | | | loudness and DRC interface ( ) |
| | | | structure |
| 8 | | Presentation | Confirmation of selection and playback |
| | | selection | of group preset according to mae_Group |
| | | | Present Definition ( ) structure |
| 9 | | Multi-stream | Confirmation of simultaneous support |
| | | | function of a maximum of two additional |
| | | | MHAS streams other than main stream |
| 10 | | Down-mix | Confirmation of whether two-channel |
| | | | output is processed in down-mix mode |
| | | | defined by the ATSC 3.0 standard |

The ATSC 3.0 standard is defined to selectively use one of AC-4 and MPEG-H for the audio coding. In this case, the assessment of compatibility appropriate for the ATSC 3.0 receiving terminal is needed. Particularly, in the case of the AC-4, loudness and presentation selection, DRC and the like is required to ensure the realistic media service of broadcasting stations, and in the case of MPEG-H, loudness and DRC, presentation selection and the like is required to ensure the realistic media service of broadcasting stations. Thus, this is stipulated in the audio test items.

The test items for function and performance of a system test specification are shown in Table 7 below.

TABLE 7

| No. | Test Items | Contents |
|---|---|---|
| 1 | Link | Confirmation of whether normal reception |
| | layer | is performed in DUT according to packet |
| | test | encapsulation mode of link layer |
| 2 | Low level | Confirmation of whether low level |
| | signaling | signaling data (service list table, rating |
| | test | region table, system time fragment, etc.) |
| | | defined by the standard is received normally |
| 3 | ROUTE-based | Confirmation of whether a service is normally |
| | service | received by DUT at the time of transmitting |
| | processing | the service using the ROUTE multiplexing |
| | confirmation | scheme |
| 4 | MMT-based | Confirmation of whether a service is normally |
| | service | received by DUT at the time of transmitting the |
| | processing | service using the MMT multiplexing scheme |
| | confirmation | |
| 5 | Service | Service test of ESG, EAS, closed caption, etc. |
| | notice and | |
| | additional | |
| | service test | |
| 6 | Capability | Confirmation of service receiving operation |
| | compatibility | compatibility between receivers with various |
| | test | capabilities |
| 7 | Plural PLP | Confirmation of whether a service is received |
| | service | by a receiver in case of distributedly |
| | | transmitting the service using two or more PLPs |

The ATSC 3.0 Link Layer Protocol has flexibility and scalability that prepare for even an input packet type which has been not defined yet without supposing data transmission of a specific format, and also provides a complicated function that selectively compresses/removes the redundancy of the header of input data. For this reason, it is required that a function of a receiver coping with all the diverse modes of a broadcasting station transmitter should be tested, and thus this is prescribed in a test specification.

In addition, since the ATSC 3.0 service includes a plurality of transmission protocols, i.e., ROUTE and MMT in the specification, security of compatibility between a transmission server and a receiver of a broadcasting station is important. Further, there is a subtle difference between ATSC 3.0 specifications by each country, and thus a problem of reception difficulty needs to be prevented, and the additional services including an ESG, a closed caption, etc., can be extended flexibly in association with a broadband, which makes it difficult to previously predict such service limitation. For this reason, a function test needs to be performed so as to be faithful to the most basic function, and thus test items for them are prescribed.

In the case of assessment test items for function and performance according to a bidirectional service specification and a broadband, verification of logic elements of an ATSC 3.0 standard receiver model for the bidirectional service defined in A/344, A/336, A/337 and A/338 is required to be performed, and the details derived as the function and performance assessment items are shown in Table 8 below.

TABLE 8

| No. | Test items | contents |
|---|---|---|
| 1 | Reception | Reception function test of service |
| | test of | transferred through broadband |
| | broadband | |
| | transmission | |
| | data | |
| 2 | Web-based | Reception function test of service using |
| | service | web-based service improvement function of |
| | signaling | broadcasting station |
| | test | |
| 3 | Interactive | Function test of runtime environment where |
| | service | web-based service can operate |
| | runtime | |
| | operation | |
| | environment | |
| | test | |
| 4 | HTML 5-based | Function test of HTML page entry operation |
| | browser | and DWD download through broadcast network/ |
| | operation | broadband network |
| | confirmation | |
| | test | |
| 5 | CSS | Confirmation test of CSS-related specification |
| | specification | support defined in W3C |
| | support | |
| | confirmation | |
| | test | |
| 6 | Companion | Confirmation test of interworking between CD |
| | Device | and PD (Primary Device) and CD (Companion |
| | interworking | Device) retrieval |
| | confirmation | |
| | test | |

An app improvement function in a broadcasting station has a high possibility of being implemented positively using very various functions provided by HTML5. Thus, since standardization of the runtime environment of a receiver is important in order to prevent the web fragmentation problem experienced in existing Internet service cases, such a problem should be able to be solved through a runtime operation environment test, and there is a high possibility that an RMP player will be implemented in a receiver at an initial stage and then will be put on the market. However, as a broadcast receiver market is extended in the future, an AMP player having a merit such as flexibility can be put on the market. Thus, it is required that a receiver function test should be essential with respect to various playback modes permitted by the standard so that a new player can be deployed without any problems in even a broadcasting environment which has already been serviced widely. Thus, the test items are set as shown in Table 8.

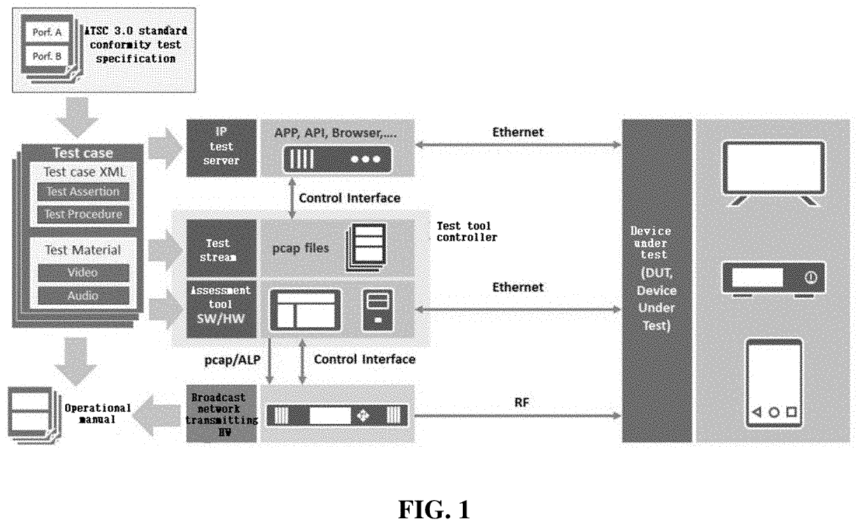

As shown in FIG. 1, an ATSC 3.0 standard conformity assessment test system according to the present invention for performing the ATSC 3.0 standard conformity assessment test as defined above includes a broadcast network transmitter, an IP test server, a test tool controller, and a device under test (DUT).

The broadcast network transmitter transmits a broadcast network assessment stream generated according to various modulation combinations (see Tables 3 and 4) defined by the ATSC 3.0 standard in response to a control signal applied thereto from the test tool controller through a broadcast network (RF) so that the standard conformity assessment test can be performed.

To this end, the broadcast network transmitter and the test tool controller should include an exclusive Ethernet port for mutual communication, and should be connected to each other by means of a network cable to perform a smooth operation.

In this case, the broadcast network transmitter and the test tool controller necessarily need not to belong to the same network, but a network connection rate enough to process stream data with high bit rate is required to be ensured, and thus they are recommended to belong to the same subnet.

In the meantime, the broadcast network transmitter needs two connection interfaces according to the use purpose for the interconnection between the broadcast network transmitter and the test tool controller.

One of the two connection interfaces is a control interface for a control command such as start/stop of a modulation operation, and the other is a data interface for receiving data to be modulated actually.

The control interface is an interface used to transmit a control signal for controlling the broadcast network transmitter in a control program installed in the test tool controller. The control interface is used to receive a monitoring report on various states of the broadcast network transmitter, and a person who performs the test controls the broadcast network transmitter and confirms the state of the broadcast network transmitter using a console-based or GUI-based software of the test tool controller.

In addition, the data interface is an interface used when receiving target data to be transmitted to the device under test (DUT) from the test tool controller by performing a modulation operation.

The connection method of connecting the test tool controller and the broadcast network transmitter employs a client-server model in which the broadcast network transmitter functions as a client, and the test tool controller functions as a server.

A protocol which is to be used in the server, i.e., the test tool controller uses a raw TCP, and a predetermined promised port is used (e.g., 9194), and a client port is not prescribed.

Since the broadcast network transmitter and the test tool controller do not implement a DHCP server function separately, they should be assigned with IPs using either IP manual setting or a separate home router device.

The broadcast network transmitter is required to grasp an address of the server (i.e., the test tool controller) to be accessed. If the type of the broadcast network transmitter is a console shape, the broadcast network transmitter can be assigned with a server IP address, but if the type of the broadcast network transmitter is a headless shape without a separate user input, the broadcast network transmitter should be configured in the form in which the server IP address has been preset.

Stream data prepared especially for verification of the test is used in a signal to be transmitted to the DUT from the broadcast network transmitter. The stream data is previously stored in a memory, and a device capable of transmitting the stream data to conform to the data interface is needed.

In a general broadcast system, a scheduler (or broadcast gateway) plays a role of providing data to an exciter device that performs a final modulation operation. In the ATSC 3.0 A/324 specification, the connection between these two devices (scheduler-exciter) is prescribed as STL (Studio-Transmitter Link) and defines the STL interface specification.

Therefore, a data interface between the test tool controller including the scheduler and the broadcast network transmitter including the exciter according to the present invention is designed to use the same STL interface. In other words, the test tool controller employs a method of reading out a test stream file that has been stored previously and transmitting the test stream file to the broadcast network transmitter to conform to the STL interface.

In addition, the IP test server transmits a communication network test stream to perform a test of an Internet-based ATSC 3.0 service such as a linkage service, an app download service, or the like using an IP communication network under the control of the test tool controller.

The test tool controller controls the operations of the IP test server and the broadcast network transmitter, performs the overall control function of the ATSC 3.0 standard conformity assessment test system using a test suite (including a test item, a procedure, assessment automation, and a test stream), and implements a function equivalent to that of a commercial test equipment through assessment result reporting and partial automation function.

Examples of the device under test (DUT) include a TV set, a set top box, a mobile terminal and the like. The device under test (DUT) transmits reception information necessary for determination of the test result to the IP test server through a feedback channel, and the reception information applied to the test tool controller through the IP test server is analyzed by the test tool controller, which in turn determines success and failure (pass/fail) of the test suite.

An unique protocol determined by the IP test server may be used in a method in which the DUT send information to the IP test server through the feedback channel, but a method based on a standard such as an “A/333:2017 Service Usage Reporting” specification of the ATSC 3.0 standard may be used.

In this case, as long as the DUT is a receiver complying with the A/333 specification, it can be used for test automation even without any separate firmware correction for automation of this test.

Further, the feedback channel should use the Ethernet capable of supporting an HTTP transmission scheme of A/333.

A DUT enabling usage reporting by implementing the A/333 function is called a “Usage Reporting-Capable Receiver (URCR)”, and a unit of information to be sent to the test tool controller through the IP test server is called a “Consumption Data Unit (CDU)”.

The CDU is transmitted to conform to a Consumption Data Message (CDM) format according to the A/333 specification.

A list of services that the URCR DUT has received so far can be accumulatively recorded in the ACDM.

The CDU can describe a start/end time with a precision of one second or less, and describes one viewing interval and several CDUs are contained in the CDM.

During an unmanned automation test, control such as change of a channel in the DUT cannot be carried out, and thus the DUT is required to be tuned to a specific channel transmitted from the broadcast network transmitter under the control of the test tool controller before automation start.

The test tool controller configures each test item, which it is desired to test, as an independent program event.

The URCR DUT collects whether to receive a broadcast signal during the test as a CDU/CDM message.

In the above example, the broadcast network transmitter is configured to use different modulation schemes according to programs, but if the DUT does not support a specific modulation scheme, a relevant program will not be received and corresponding program information will be omitted from CDU/CDM message collection data.

The test tool controller that has received this information can determine that a corresponding modulation scheme test is fail.

An address of a URL of the IP test server to which the URCR DUT is to transmit the accumulatively collected CDU/CDM messages is described in an LLS/SLT created by the IP test server.

The URCR DUT performs channel retrieval by a test engineer's manual manipulation before the start of the automation test, and in this process, when the URCR DUT receives an SLT to configure a channel list, it acquires information regarding a server address to which the CDU/CDM message is reported.

An example of the operation of the test system of the present invention will be described hereinafter.

First, a broadcast network transmission stream for the test is composed of four programs as follows (time indicated below is based on Korean local time, i.e., GMT+9:00):

Program 1: 2018/11/9 9:12:00˜2018/11/9 9:12:10

Program 2: 2018/11/9 9:12:10˜2018/11/9 9:12:20

Program 3: 2018/11/9 9:12:20˜2018/11/9 9:12:30

Program 4: 2018/11/9 9:12:30˜2018/11/9 9:12:40.

The following RF transmission parameters are common: frequency-701 MHz; output level-27 dB; and bandwidth-6 MHz. In addition, transmission is performed with varying modulation/code rate only as follows:

Program 1: QPSK, 6/15

Program 2: QPSK 7/15

Program 3: QPSK 8/15

Program 4: QPSK 9/15.

The broadcast network transmitter of a test tool prepare for the transmission as described above, and sets a channel so as to receive a signal from the device under test (DUT) (a frequency of 701 MHz).

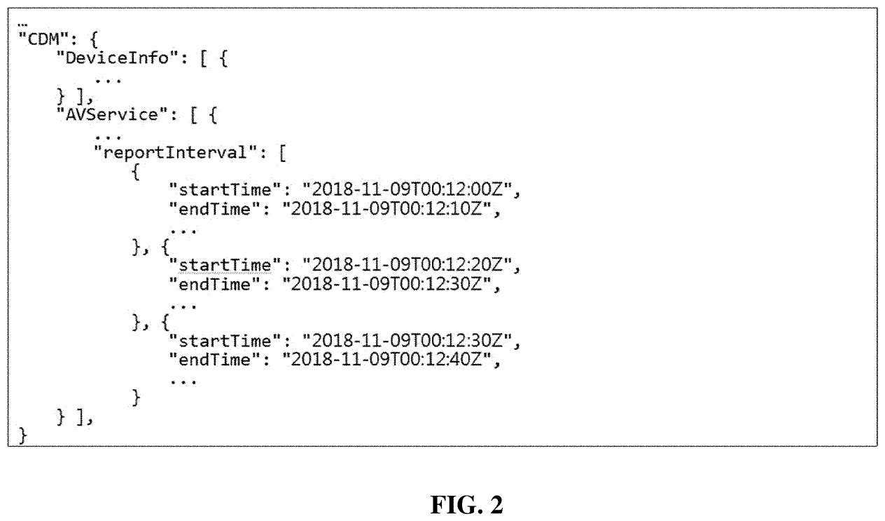

When the broadcast network transmitter transmits a signal, the DUT receives programs 1 to 4 sequentially. If it is determined that they have been received normally, information is collected in a viewing history and then is transferred to a server as a CDM message as shown in FIG. 2.

In this case, when the receiver is operated normally, the viewing history is described in a list called a report interval. The startTime and the endTime are denoted by UTC. For example, the start time of program 1 is 2018/11/9 9:12:00 based on the Korean time. When this start time is indicated by UTC, it can be displayed as 2018-11-09T00:12:00Z on the CDM.

In the above example the first interval started at a.m. 9:12:00GMT+09:00 on Friday on Nov. 9, 2018 and ended at a.m. 9:12:10GMT+09:00 on Friday on Nov. 9, 2018:

Interval 1: 2018/11/9 9:12:00˜2018/11/9 9:12:10

Interval 2: 2018/11/9 9:12:20˜2018/11/9 9:12:30

Interval 3: 2018/11/9 9:12:30˜2018/11/9 9:12:40.

The A/33 server can grasp that the receiver did properly receive a pat corresponding to program 2 from this CDM message. This information is transferred to the test tool controller.

The test tool controller grasps the fact that program 2 is supposed to be transmitted with QPSK 7/15, and thus it can determine that a relevant receiver was not successful in a QPSK 7/15 parameter reception test and this is fail.

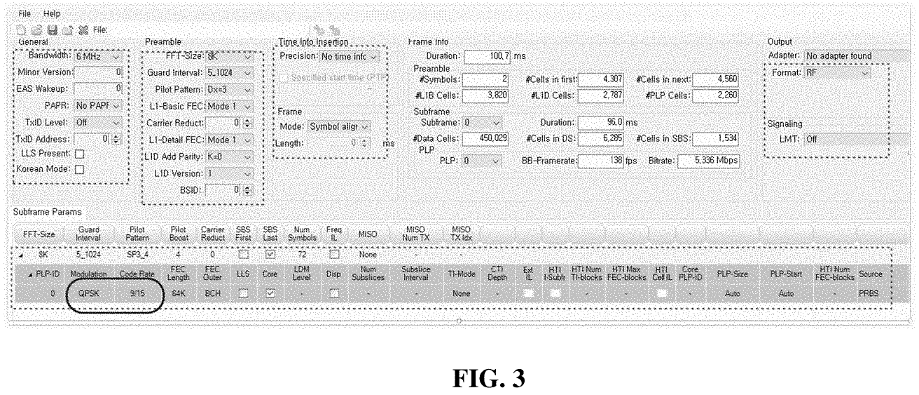

Parameters for this test can be set by a user through a console or a GUI of the test tool controller. As an example of the parameters, when the GUI of the broadcast network transmitter is checked as shown in FIG. 3, all the red dotted lines are FR transmission parameters, and among these parameter, an example of a test of variously modifying a part corresponding to QPSK 9/15 (blue mark) is shown.

While the ATSC 3.0 standard conformity assessment test system according to the present invention have been described and illustrated in connection with specific exemplary embodiments with reference to the accompanying drawings, it will be readily appreciated by those skilled in the art that it is merely illustrative of the preferred embodiments of the present invention and various modifications and changes can be made thereto within the spirit and scope of the present invention, set forth in the claims.

What is claimed is:

1. An ATSC 3.0 standard conformity assessment test system configured to automatically perform an ATSC 3.0 standard conformity assessment test, the system comprising:
a broadcast network transmitter for modulating inputted transmission data according to a number of modulation combinations defined by the ATSC 3.0 standard to generate a broadcast network assessment stream, and transmitting the generated broadcast network assessment stream through a broadcast network (RF) in response to a control signal applied thereto;
an IP test server for transmitting a communication network test stream for an Internet-based ATSC 3.0 service test using an IP communication network in response to a control signal applied thereto;
a device under test (DUT) for transmitting reception information with respect to the broadcast network assessment stream transmitted from the broadcast network transmitter and the communication network test stream transmitted from the IP test server to the IP test server through a feedback channel; and
a test tool controller for fetching a test suite including a test item, a procedure, assessment automation, and a test stream, which have been stored in a memory and outputting control signals for transmission of the communication network test stream and the broadcast network assessment stream, respectively, to the IP test server and the broadcast network transmitter, and determining success and failure (pass/fail) of reception based on the reception information inputted thereto from the device under test (DUT) through the IP test server.

2. The ATSC standard conformity assessment test system according to claim 1, wherein a data interface between the test tool controller including a scheduler and the broadcast network transmitter including an exciter uses an STL interface, and the test tool controller reads out a test stream file that has been stored previously and transmits the test stream file to the broadcast network transmitter to conform to the STL interface.

3. The ATSC standard conformity assessment test system according to claim 1, wherein either an unique protocol determined by the IP test server or an “A/333:2017 Service Usage Reporting” specification of the ATSC 3.0 standard is used in a method in which the DUT send information to the IP test server through the feedback channel so that as long as the DUT is a receiver complying with the A/333 specification, it can be used for test automation even without any separate firmware correction.

4. The ATSC standard conformity assessment test system according to claim 3, wherein the feedback channel uses the Ethernet capable of supporting an HTTP transmission scheme of A/333.

5. The ATSC standard conformity assessment test system according to claim 3, wherein the CDU is transmitted to conform to a Consumption Data Message (CDM) format capable of accumulatively recording a list of services that the URCR DUT has received so far according to the A/333 specification, and the URCR is a “Usage Reporting-Capable Receiver (URCR) as a DUT enabling usage reporting by implementing the A/333 function.

6. The ATSC standard conformity assessment test system according to claim 1, wherein the DUT is tuned to a specific channel which is transmitted from the broadcast network transmitter in response to a control signal transmitted from the test tool controller before the ATSC 3.0 standard conformity assessment test.

7. The ATSC standard conformity assessment test system according to claim 1, wherein the test tool controller configures each test item, which it is desired to test, as an independent program event and determines pass/fail of the test in the unit of a program time.

8. The ATSC standard conformity assessment test system according to claim 5, wherein an address of a URL of the IP test server to which the URCR DUT is to transmit the accumulatively collected CDU/CDM messages is described in an LLS/SLT created by the IP test server, and the URCR DUT acquires information regarding a server address to which the CDU/CDM message is reported when receiving an SLT to configure a channel list in a process of performing a channel retrieval before the ATSC 3.0 standard conformity assessment test.
